(19) United States
(12) Patent Application Publication
(10) Pub. No.: US 2015/0166843 A1
(43) Pub. Date: Jun. 18, 2015

(54) Labeling tear tape

(71) Applicant: Johannes Blok, Perth Amboy, NJ (US)

(72) Inventor: Johannes Blok, Perth Amboy, NJ (US)

(73) Assignee: Broadway Kleer-Guard Corp.

(21) Appl. No.: 13/998,867

(22) Filed: Dec. 16, 2013

(51) Int. Cl. C09J 7/02

(52) U.S. Cl. CPC C09J 7/0242; C09J 7/0275; C09J 2201/122; C09J 2201/61; C09J 2203/334; C09J 2423/106

(57) ABSTRACT

Tapes which allow variable information to be filled in by the user, wherein the tape can be torn by hand by the user.

### FIELD OF THE INVENTION

The present invention relates to tapes which allow variable information to be filled in by the user and the tape to be easily torn by hand.

### BACKGROUND OF THE INVENTION

Adhesive tape sticks with application pressure, without the need for solvent, heat or water for activation are known. It can be used in the home, office, industry, and institutions for a wide variety of purposes. The tape may have a release liner which protects adhesive until the liner is removed. Some have layers of adhesives, primers, easy release materials, filaments, printing, etc. made for specific functions.

Single-sided tapes allow bonding to a surface or joining of two adjacent or overlapping materials. Double-sided tape (adhesive on both sides) allows joining of two items back-to-back.

Originally, pressure sensitive tape was made with natural rubber as the adhesive, however, even though this is still available, most tape is produced using hot melt or synthetic materials.

Before the adhesive is applied, the film is typically chemically treated (primed) or corona treated before being coated, while the side that does not receive the coating may be treated with a release agent that enables the tape to be wound and unwound without sticking together. The release agent however, generally prevents any ink sticking to its surface, so normally this type of tape cannot be printed on or written on with a marker.

U.S. Pat. No. 7,197,842 relates to a flexible, substantially non-stretchable, imprintable tape which includes lines of weakness constituting tear lines defining in outline a longitudinal series of symmetrical identification bracelets. Each bracelet has a rectangular imprintable portion, a first elongated strap portion at one end, and a second elongated strap portion at the opposite end. The imprintable portion has a width equal to the width of the tape and the first and second portions have a width substantially less than that of the tape.

U.S. Pat. No. 7,150,802 relates to a method of applying fiscal indicia, such as a tax stamp to an article wherein the article is enclosed at least in part by a film packaging material with an associated tear tape, the tear tape comprising a base film of oriented thermoplastic having a coating of pressure sensitive adhesive on one side of the film and with a coating of release agent on the opposite side, wherein the tear tape carries the fiscal indicia such as a tax stamp thereon.

U.S. Pat. No. 4,887,714 relates to a narrow tape of polyester or other suitable plastic for use as a tear tape in the packaging industry slit from a wide web of material, is coated wholly on one side and at the edges with a suitable release material. Downstream of the slitting the tape is printed on the other side, then coated over the printing with a suitable pressure sensitive adhesive, said coating width being narrower than the width of the tape covering the printing and spaced from both side edges of the tape to avoid pick-off onto tape guide surfaces. The tape is then wound onto the core with both radial and axial traversing movements. The tape is then supplied to the packaging line preformed with adhesive to avoid on-line adhesive applications.

U.S. Pat. No. 4,836,378 relates to a novel tear strip or sealing strip for a package or container is disclosed. The tear strip or sealing strip comprises a plastic film substrate upon which a magnetizable metal oxide coating has been deposited. The coated strip may be adhered to the package or the flexible wrapping material for the package or the container. Optionally, the strip may be coated with a pigment or metallized or printed with graphic indicia or any combination of these features. Information may be recorded on the magnetic coating during packaging and handling for subsequent readout.

U.S. Pat. No. 5,401,110 relates to a label printer uses a continuous strip of label paper on which customized size labels are printed. The printer is operated by a microprocessor into which label criteria, such as size, print content, type, and the like are inputted. Specimen tubes having machine readable labels on them are scanned by a scanner connected to the microprocessor so as to identify the respective sizes of the specimen tubes, and type of label desired. The printer has a label paper strip perforator which is controlled by the microprocessor so as to produce properly sized labels for affixation to the specimen tubes. The printed labels can be used for different lab labeling requirements such as slides or other tubes.

US patent publication no. 2001/0000741 relates to a substrate, such as the surface of goods or of packaging material for goods, is provided with a security device by applying, to the substrate, a pressure sensitive adhesive tape carrying a security device in the form of a hologram.

US patent publication no. 2007/0283589 relates to a universal template tape for use in construction, home improvement and various crafts. The tape has an adhesive backing , while the non-adhesive side of the tape bears a regularly spaced set of indicia. The indicia includes a combination of distance markers perpendicular to the edges off the tape. The indicia further include a grid of regularly spaced parallel lines forming a forty-five degree angle with the edges of the tape. The embodiments of the template tape include combinations of different distance markers and grids.

### SUMMARY OF THE INVENTION

The present invention relates to pre-printed tapes wherein a user fills in various information on the tape. It is an object of the present invention for the tape to be used for closing packages.

The present invention relates to a pressure sensitive tape, also known as adhesive tape or sticky tape. It is an object of the present invention for the tape to comprise a pressure sensitive adhesive coated onto a backing material made of plastic film. It is an object of the present invention for the film to be BOPP (Biaxially Oriented Poly Propylene).

The present invention is a ready print tape that is a BOPP based hot melt tape with a modified release coating so that it is printed on the uncoated side. The ability to print on the tape also means that the tape can be written on with permanent markers, like paper tape. This turns this economical type of plastic tape into pre-printed forms where other information is filled out by the user. It is an object of the present invention for the tape to be produced so that it is easily torn by hand, eliminating the need for a separate dispenser.

The present invention is a tape comprising: a hot melt tape having a coated side and an uncoated side. The coated side comprises an adhesive coating on a backing material made of plastic film. The uncoated side has pre-printed information printed on it. The uncoated side is made of a material where a user prints with a writing implement on the uncoated side.

It is an object of the present invention for the user to fill in various information on the uncoated side of the tape. It is an object of the present invention for the tape to be used for closing packages. Therefore the tape must be made of sufficient strength to accomplish this purpose.

It is an object of the present invention for the film to be comprised of biaxially oriented poly propylene.

It is an object of the present invention for the tape to be written on with permanent markers.

It is an object of the present invention for the tape to be wound on a roll. It is an object of the present invention for the tape to be torn by hand. It is an object of the present invention for the tape to have perforations to assist the user in tearing the tape off of the wound roll. It is an object of the present invention for the tape to be used in closure and moving of a product in the moving and storage industry.

It is an object of the present invention for the tape to be used as an address label. It is an object of the present invention for the pre-printed information to comprise various messages, designs and other private label information.

It is an object of the present invention for the pre-printed information to address the contents of what is in the package. It is an object of the present invention to provide pre-printed information on the tape about rooms in a house, where a user then marks on the tape what room the package is to be delivered. It is an object of the present invention to provide pre-printed information where a user fills in the dates that the contents of the package were placed in the package. It is an object of the present invention to provide pre-printed information where a user fills in dates for contents of package to be destroyed.

### BRIEF DESCRIPTION OF DRAWINGS

FIG. 1 shows an embodiment of the present invention showing use of the product in the moving and storage industry.

FIG. 2 shows an embodiment of the present invention showing the use of the product as an address label.

FIG. 3 shows an embodiment of the present invention showing the use of the product as an address label with no information printed on the tape.

FIG. 4 shows an embodiment of the present invention showing the use of the product as an address label with information printed on the tape.

FIG. 5 shows an embodiment of the present invention showing the use of the product having pre-printed information and printed information on the tape.

### DETAILED DESCRIPTION OF THE INVENTION

In an embodiment, tape is printed with various messages (e.g., “Fragile”), designs and other private label information. To produce printed tape for mass production applications, the film is treated first, and then printed in reverse after which the coating is applied over the print. Since the back of the tape has a release coat on it, regular permanent ink does not stick to the surface, so these tapes cannot be written upon with a marker. The one exception is PVC tape which accepts ink. PVC tape however is significantly more expensive. Other substrates that include the ability to write includes tape made of paper. Paper can be written on both with markers and even regular ball pens. Paper tape is easily torn by hand. Paper tape, however, is expensive.

Ready print tape is a hot melt tape with a modified release coating to enable it to be printed on the uncoated side. The ability to print on the tape also means that the tapes can be written on very much like paper tape. This provides the ability to the economical tape into pre-printed forms where other information is filled out by the user. A potential application is in the moving and storage industry where the contents of the carton are written on the tape itself; no additional labels are required.

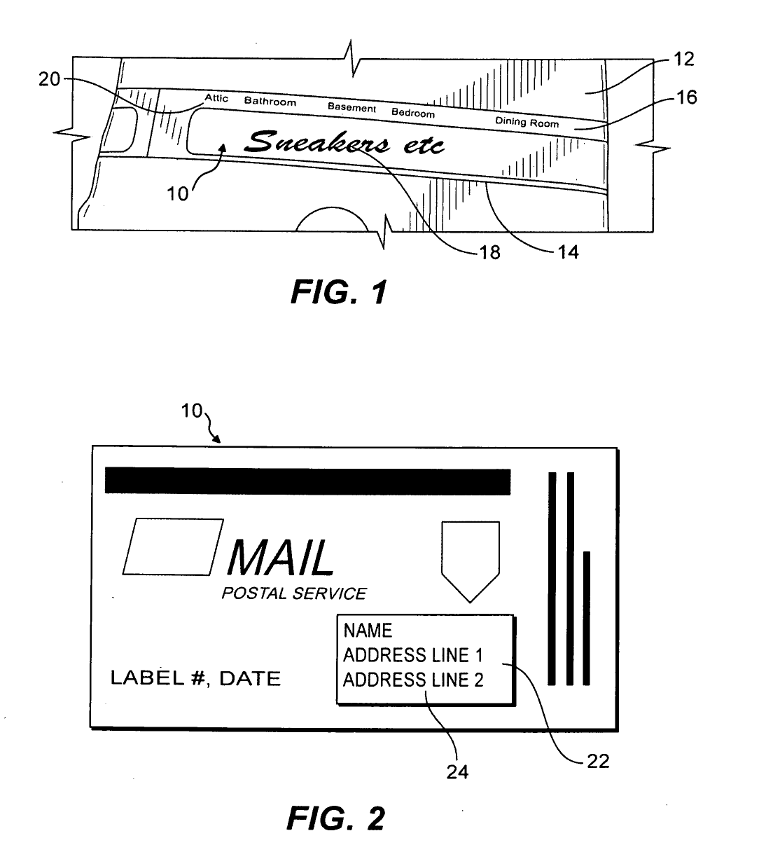

FIG. 1 shows the tape 10 of the present invention being sealed on a box 12, using a sealing mechanism 14, such as an adhesive 14. The uncoated or non-adhesive side 16, comprises a material wherein the user writes information onto the uncoated side 16. The tape 10 also has pre-printed information 20.

FIG. 2 shows the tape 10 having an address label pre-printed 22, wherein the user fills in the rest of the information 24, without the need for additional labels.

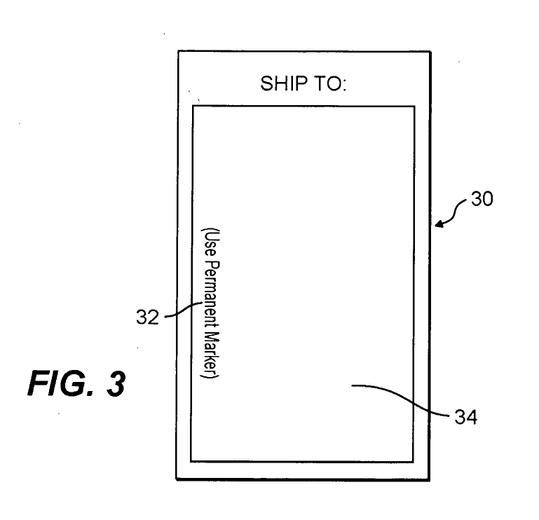

FIG. 3 shows the tape 30 having pre-printed information 32, wherein the user can print further information in the space 34.

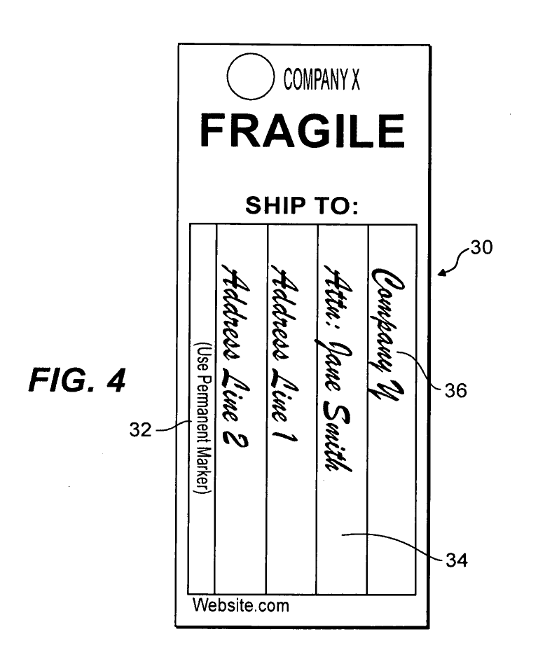

FIG. 4 shows the tape 30 having pre-printed information 32, wherein the user has printed information 36 in the space 34.

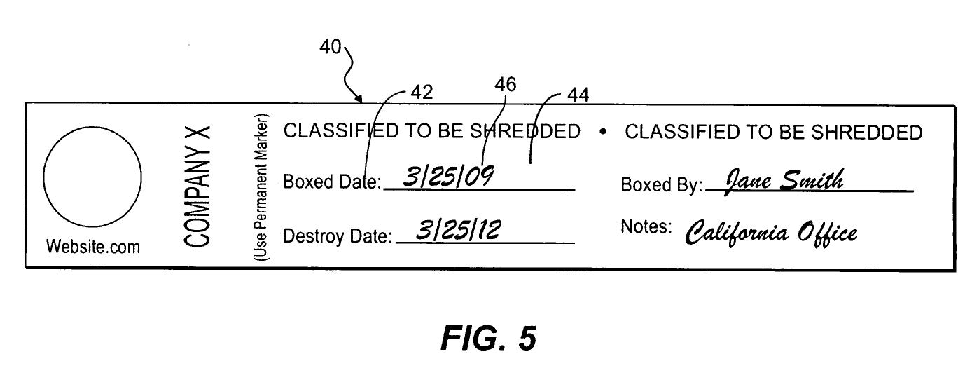

FIG. 5 shows the tape 40 having pre-printed information 42, wherein the user has printed information 46 in the space 44.

1. A tape comprising:
hot melt tape;
said tape having a coated side and an uncoated side;
said coated side comprising an adhesive coating on a backing material made of plastic film;
said uncoated side having pre-printed information printed on it;
said uncoated side having a material that a user can print on the tape so that it is oriented on by the user.

2. The tape of claim 1 wherein a user fills in various information on said tape.

3. The tape of claim 1 wherein said tape is used for closing packages.

4. The tape of claim 1 wherein said film comprises biaxially oriented poly propylene.

5. The tape of claim 1 wherein said tape is written on with permanent markers.

6. The tape of claim 1 wherein said tape is wound on a roll.

7. The tape of claim 6 wherein said tape is torn by hand.

8. The tape of claim 1 wherein said tape is used in closure and moving of a product in moving and storage industry.

9. The tape of claim 1 wherein said tape is used as an address label.

10. The tape of claim 1 wherein said pre-printed information comprises various messages, designs and other private label information.

11. The tape of claim 10 wherein said pre-printed information addresses contents of what is in said package.

12. The tape of claim 10 wherein said pre-printed information on said the tape is information about rooms in a house, where a user marks on said tape what room said package is to be delivered.

13. The tape of claim 10 wherein said pre-printed information provides space where a user fills in dates when contents of said package were placed in said package.

14. The tape of claim 10 wherein said pre-printed information provides space where a user fills in dates when contents of said package are to be destroyed.
